(19) United States
(12) Patent Application Publication
(10) Pub. No.: US 2025/0099861 A1
(43) Pub. Date: Mar. 27, 2025

(54) YOKE SUPPORT FRAME ASSEMBLY AND METHOD OF USE THEREOF

(71) Applicant: Next Level Racing Simulations Pty Ltd, Southport (AU)

(72) Inventor: Hessam Ghahramanian, Southport (AU)

(73) Assignee: Next Level Racing Simulations Pty Ltd, Southport (AU)

(21) Appl. No.: 18/722,967

(22) PCT Filed: Dec. 22, 2022
(86) PCT No.: PCT/AU2022/051558

§ 371 Date: Jun. 21, 2024

(30) Foreign Application Priority Data
Dec. 23, 2021 (AU) 2021904229

(51) Int. Cl. A63F 13/90; A63F 13/803; G09B 9/08

(52) U.S. Cl. CPC A63F 13/90; A63F 13/803; G09B 9/08

(57) ABSTRACT

The present invention relates to a yoke support frame assembly and parts and methods of use thereof for a flight simulator cockpit. In one form, there is provided a yoke support frame assembly for a flight simulator cockpit, said support frame assembly including: an elongate member having an upper end for supporting a yoke thereon centrally in front of a flight simulator cockpit occupant and an opposed lower end configured to be pivotally mounted to a base frame of the flight simulator cockpit such that the yoke support frame is pivotable between a folded position in which the yoke support frame pivots towards the base frame and an operable position in which the yoke support frame stands proud relative to the base frame; and at least one locking arrangement for releasably securing the yoke support frame in the operable position relative to the base frame.

### TECHNICAL FIELD

The present invention relates to a yoke support frame assembly and parts and methods of use thereof for a flight simulator cockpit.

### BACKGROUND

Flight simulation is used for a variety of reasons, including flight training (mainly of pilots), the design and development of aircraft, research into aircraft characteristics and control handling qualities as well as recreational activity.

Generally, a wide range of flight simulators are available ranging from base models including a display, a seat and a joystick to high end permanent flight simulator cockpit structures mounted atop one or more motion simulators.

Accordingly, a problem in general with base and lower end models is that the simulators lack the authenticity of a plane's cockpit environment. For example, it is common practice with such models to use an ordinary chair with a desk or desktop simulator, which severely detracts from the simulator experience creating a disconnect between the occupant and the simulated flying experience.

Further, the cost of having a high end permanent flight simulator cockpit is generally outside the budget of most hobby flight enthusiasts and even commercial pilots.

The applicant has previously addressed these problems by providing flight simulator cockpits in kit or assembly forms. Such kits or assemblies usually include a base frame, a seat, a pedal set and a joystick or yoke which all together can be positioned in front of one or more displays to provide a more genuine flight experience.

However, the applicant has realised that its previously provided flight simulator cockpits can be improved to enhance their authenticity, versatility and usability.

For example, the cockpit frames are prone to becoming overcrowded and difficult for users to enter and exit the cockpit frame. Further, the assembled cockpits still generally lack the required rigidity to provide a truly authentic simulated flying experience.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide a support frame assembly, a yoke support frame assembly and parts and methods of use thereof for use with a flight simulator cockpit, which may at least partially address one or more of the problems or deficiencies mentioned above or which may provide the public with a useful or commercial choice.

According to a first aspect of the present invention, there is provided a support frame assembly for a flight simulator cockpit, said support frame assembly including:
a base frame defining a forward end and an opposed rear end;
a seat mounted to the base frame at or near the rear end;
a pedal set support frame mounted to the base frame at or near the forward end for supporting a pedal set thereon;
a yoke support frame extending upwardly from the base frame at a location positioned in front of the seat for supporting a yoke centrally in front of a seated occupant, said yoke support frame including an elongate member having an upper end for supporting the yoke thereon and an opposed lower end pivotally mounted to the base frame so that the yoke support frame is pivotable between a folded position in which the yoke support frame pivots towards the base frame and an operable position in which the yoke support frame stands proud relative to the base frame; and
at least one locking arrangement for releasably securing the yoke support frame in the operable position relative to the base frame.

According to a second aspect of the present invention, there is provided a yoke support frame assembly for a flight simulator cockpit, said support frame assembly including:
an elongate member having an upper end for supporting a yoke thereon centrally in front of a flight simulator cockpit occupant and an opposed lower end configured to be pivotally mounted to a base frame of the flight simulator cockpit such that the yoke support frame is pivotable between a folded position in which the yoke support frame pivots towards the base frame and an operable position in which the yoke support frame stands proud relative to the base frame; and
at least one locking arrangement for releasably securing the yoke support frame in the operable position relative to the base frame.

Advantageously, the support frame assembly and yoke support frame assembly of the present invention provide a flight simulator that has the required rigidity to provide a truly authentic simulated flying experience, while still being affordable for professional pilots and even hobby flight enthusiasts. Further, the assembly components can be readily adjusted relative to one another to adapt the assembly to various cockpit configurations while still maintaining the required rigidity. Lastly, the pivotable yoke support frame enables the assembly to provide support for various configurations while still enabling an occupant to safely enter and exit the cockpit.

As indicated, the support frame assembly, the yoke support frame assembly and parts thereof are for use with a flight simulator cockpit, preferably interchangeable between at least two configurations. For example, the support frame assembly is configured to support a flight simulator cockpit for at least a domestic or commercial aircraft configuration and a military aircraft configuration, preferably a fighter configuration.

As used herein, the terms “domestic aircraft configuration” and “commercial aircraft configuration” refer to a cockpit configuration configured to simulate a domestic or commercial aircraft cockpit, such as, e.g., that of a Cessna or airliner. The domestic or commercial air craft configuration may be characterised by the presence of a yoke for controlling the altitude, usually in both pitch and roll, of an aircraft.

As used herein, the term “military aircraft configuration” refers to a cockpit configuration configured to simulate a military aircraft cockpit, such as, e.g., that of combat aircraft, including fighter jets and attack helicopters. The military aircraft configuration may be characterised by the presence of a centre stick in lieu of a yoke.

As indicated, the support frame assembly includes a base frame defining a forward end and an opposed rear end of the support frame assembly, and preferably opposed sides extending longitudinally therebetween.

The base frame may be of any suitable size, shape and construction for supporting a remainder of the support frame assembly relative to a support surface and may be formed from any suitable material or materials. For example, the base frame may be formed from metal and/or plastic material or materials, preferably the former, more preferably aluminium, steel, titanium or a composite thereof.

The base frame may be rectangular, circular, triangular, pentagonal, hexagonal, heptagonal, octagonal or any variation or combination thereof, preferably rectangular.

Typically, the base frame may be formed from two or more frame members joined together.

For example, in some embodiments the base frame may include at least a pair of longitudinally extending side frame members extending between the forward and rear ends. The pair of side frame members may be joined together by one or more transversely extending cross frame members.

In some such embodiments, the base frame may include at least a pair of longitudinally extending side frame members extending between the forward and rear ends. The pair of side frame members may be joined together by a forward cross frame member located at or near the forward end, a rear cross frame member located at or near the rear end and at least a yoke support cross frame member located rear of the pedal set support frame and from which the yoke support frame is pivotally mounted.

In other such embodiments, the pair of side frame members may be joined together by forward cross frame member located at or near the forward end, a rear cross frame member located at or near the rear end, a yoke support cross frame member located near the pedal set support frame and from which the yoke support frame is pivotally mounted, and a centre stick support cross frame member located immediately in front of the seat and to which the centre stick support frame is mounted.

The forward and rear cross frame members may respectively define the forward and rear ends of the base frame.

The frame members may be of tubular or solid construction, preferably the former. Each frame member may have a substantially circular, oval or rectangular cross-section, preferably rectangular.

Each frame member may include a pair of opposed ends and an elongate body having at least one sidewall extending therebetween, preferably in a linear direction. The elongate body may preferably be defined by four sidewalls, including an upper wall, an opposed lower wall and opposed sidewalls. Each end and/or end portion may be adapted to be connectable either directly or indirectly with other frame members to assemble the base frame.

The frame members may be constructed in any suitable way. For example, the frame members may be machine folded from sheet metal or may be extrusions, typically the latter.

The various frame members may be joined together using conventional welding techniques and/or with one or more mechanical fasteners.

In some embodiments, the pair of side frame members may include one or more bends for defining a raised seat mount near the rear end and atop of which the seat may be mounted. The seat mount may be configured to position the seat at an optimal height above the support surface so that an occupant can readily view one or more display screens and/or access one or more controls positioned in front.

The side frame members forming the raised seat mount may include three portions when viewed from a side: a first portion, a second portion and a third portion that together form the raised seat mount. Typically, the first and third portions are angled relative to the support surface and the second portion bridges the first and third portions and extends substantially parallel to the support surface. The first and third portions may preferably be acutely angled relative to the support surface.

In some embodiments, the base frame may include wheels for moving the base frame (and a remainder of the support frame assembly) along the support surface. The wheels may be located on, or mounted to, an underside of the base frame. The wheels may be mounted directly or indirectly to the base frame.

In other embodiments, the base frame may include one or more feet for supporting the base frame (and a remainder of the support frame assembly) atop the support surface. The one or more feet may be of any suitable size, shape and construction and may be operatively associated with the base frame in any suitable way.

Generally, the one or more feet may be formed from rubber or plastic material or materials, preferably plastic material or materials.

In preferred embodiments, each foot may be height adjustable by rotating the foot relative to the base frame.

In some embodiments, the various frame members forming the base frame may include one or more apertures defined in walls thereon for mounting various components. The one or more apertures may preferably be defined in the sidewalls of the side frame members.

For example, in some such embodiments, one or more apertures may be defined in sidewalls of the second portion of the side frame members for the mounting of the seat, either directly or indirectly, to the base frame.

In other embodiments, the one or more apertures may be defined in the sidewalls of the side frame members at a forward end portion thereof for the mounting of the pedal set support frame thereto.

In some embodiments, the one or more apertures may include substantially circular apertures for the fixed mounting of various components thereto with one or more mechanical fasteners.

In other embodiments, the one or more apertures may include elongate apertures extending at least partially along a length of the frame members for the mounting of various components thereto with one or more mechanical fasteners so that they may be slidably adjustable therealong.

As indicated, the support frame assembly includes a seat mounted to the base frame at or near the rear end, preferably to the raised seat mount.

Generally, the seat may be of any suitable size, shape and construction for use with a flight simulator.

The seat may include an adjustable backrest configured to pivot relative to the seat base.

In embodiments in which the simulator includes a centre stick, the forward edge of the base of the seat may include a cut out portion configured to at least partially accommodate a centre stick support frame extending upwardly at least partially therethrough. This is particularly desirable in military aircraft configurations.

The seat may be directly or indirectly mounted to the raised seat mount, preferably indirectly.

In some embodiments the seat and the raised seat mount may be fastened together by one or more seat brackets, for example.

In such embodiments, each bracket may have a substantially L-shaped cross section having a base frame engaging portion configured to be fastened to a sidewall of a side frame member and a seat engaging portion extending orthogonally relative to the seat engaging portion and configured to be fastened to an underside of a base of the seat.

In other embodiments, the seat may be mounted to the raise seat mount of the base frame by way of a seat slider configured to enable the seat to be slidably adjustable relative to the base frame.

The seat slider may be of any suitable size, shape and construction known in the art.

As indicated, the support frame assembly further includes a pedal set support frame for supporting a pedal set thereon.

The pedal set support frame may be of any suitable size, shape and construction to have a pedal set mounted thereon and preferably be slidably mounted to the base frame.

Typically, the pedal set support frame may include at least one frame member configured to extend longitudinally between the opposed side frame members of the base frame and a pedal set support bracket mounted atop the at least one frame for supporting the pedal set thereon.

The at least one frame member may include a pair of opposed ends and an elongate body extending therebetween, preferably linearly.

Each end may be configured to slidably mountable to an inner sidewall of an adjacent side frame member, preferably via one or more mechanical fasteners received through elongate apertures defined in the sidewalls as previously described.

In some embodiments, the opposed ends may each include a folded flange portion for connection to the inner sidewall of the adjacent side frame member, preferably orthogonally folded. Each folded flange portion may include one or more apertures defined thereon for receiving one or more mechanical fasteners therethrough for fastening to the side frame member.

The elongate body of the at least one frame member may include an upper wall on which the pedal set support bracket is mounted. The upper wall may include a forward edge and an opposed rear edge.

In preferred embodiments, the upper wall of the at least one frame member may include a negative gradient extending from the forward edge to the rear edge such that the pedal set support bracket when mounted thereon may be at least partially angled towards the seat.

The pedal set support bracket may be of any suitable size, shape and construction for having the pedal set mounted thereon.

Typically, the bracket may have an elongate planar shape. The bracket may include a pair of opposed surfaces, including an upper surface and an opposed lower surface. The opposed surfaces may extend substantially parallel to one another and be interconnected by opposing edges.

The opposed edges may include a forward edge, an opposed rear edge and opposed side edges.

In some embodiments, the bracket may include one or more apertures extending along the opposed sides for fastening the bracket atop the at least one frame member. Preferably, the one or more apertures are elongate apertures so as to enable the bracket to be slidably adjusted relative to the at least one frame member. The elongate apertures may extend longitudinally at least partially along the opposed sides of the upper surface of the bracket between the forward and rear edges, preferably entirely along.

As indicated, the support frame assembly includes a yoke support frame extending upwardly from the base frame for supporting a yoke relative to the base frame in a position centrally positioned in front of a seated occupant, said yoke support frame being pivotable relative to the base frame between a folded position in which the yoke support frame pivots towards the base frame and an operable position in which the yoke support frame stands proud relative to the base frame.

The yoke support frame may be of any suitable size, shape and construction. The yoke support frame may be of unitary construction or may be formed from two or more yoke support frame pieces, preferably the latter.

Generally, the yoke support frame may include an elongate member having an upper end for supporting the yoke thereon and an opposed lower end configured to be pivotally coupled to the base frame, preferably to a central portion of the yoke support cross frame member.

The elongate member may be of tubular or solid construction, preferably the former. The elongate member may have a substantially circular, oval or rectangular cross-section, preferably rectangular.

The elongate member may be defined by at least one sidewall, preferably four sidewalls extending longitudinally between the opposed ends.

The elongate member may be of a fixed height as defined between the opposed ends or may be adjustable, preferably the latter.

In some embodiments, the height of the elongate member and thus the yoke support frame may be adjustable by a telescopic arrangement. For example, the elongate member may include two or more telescoping member portions slidable relative to each other between a retracted position and an extended position to thereby adjust a height of the elongate member.

In preferred such embodiments, the elongate member may include a lower member portion and an upper member portion slidable relative to the lower member portion between a retracted position and an extended position to thereby adjust a height of the elongate member.

In such embodiments, the elongate member may further include a retaining mechanism for retaining the member portions at a set height. Any suitable type of retaining mechanism may be used.

For example, in some such embodiments, the support portions may be locked relative to one another at a set height by a locking pin extending through co-aligned apertures in the sidewalls of the portions. The locking pin may be a conventional locking pin or may be a spring-loaded locking pin.

In other embodiments, the retaining mechanism may include a first part associated with one of the portions and a second part connectable to the first part and associated with the other of the portions. The retaining mechanism may include mateable male and female portions that couple together, such as, e.g., a threaded connection, an interference connection or a friction fit-type connection.

For example, in some such embodiments, the first part of the retaining mechanism associated with a sidewall of one of the portions may include a male formation configured to be inserted into, or coupled with, a female formation of the second part of the retaining mechanism associated with the other of the portions.

In other embodiments, the retaining mechanism may include a clamping device for clamping the portions relative to one another, such as, e.g., a quick release clamp assembly.

In preferred embodiments, the lower member portion may include one or more elongate apertures extending at least partially along a height of the portion and the upper member portion may include one or more threaded shanks configured to protrude outwardly from a sidewall of the upper member portion and through the elongate apertures, be slidable along the elongate apertures and have a threaded fastener fastened thereon to retain or clamp the upper member portion relative to the lower member portion at a set height.

The lower member portion may preferably extend linearly between a lower end and an opposed upper end in which the upper member portion is slidably received.

In some embodiments, the upper member portion may extend linearly between a lower end portion configured to be at least partially received in the upper end of the lower member portion and an upper end on which the yoke is mounted.

In other embodiments, the upper member portion may include a linear lower end configured to be at least partially received in the upper end of the lower member portion and an angled upper end configured to define a mounting surface for the yoke.

In preferred such embodiments, the upper end of the upper member portion may include one or more angled bends, preferably defining an angular crook facing the seat having an upper substantially planar surface for the mounting of the yoke thereon.

The yoke may be directly or indirectly mounted to the elongate member, preferably the latter.

Preferably, the yoke support frame may further include a yoke support bracket mounted atop the elongate member for supporting the yoke thereon.

The yoke support bracket may be of any suitable size, shape and construction for having the yoke mounted thereon.

Typically, the bracket may have an elongate planar shape. The bracket may include a pair of opposed surfaces, including an upper surface and an opposed lower surface. The opposed surfaces may extend substantially parallel to one another and be interconnected by opposing edges.

The bracket may be mounted atop the elongate member by one or more mechanical fasteners.

Similarly, the bracket may include one or more apertures defined thereon for receiving one or more mechanical fasteners therethrough for fastening the yoke to the bracket.

The elongate member may be pivotally mounted to the base frame in any suitable way that allows the elongate member to pivot about the lower end and the upper end to be pivotable between the operable and folded positions.

Typically, the elongate member and the base frame may be hingedly connected by at least one hinge or part thereof.

The at least one hinge may be of any suitable size, shape and construction and formed from any suitable material or materials.

The at least one hinge or parts thereof may or may not be of integral formation with the elongate member and the base frame.

In some embodiments, the at least one hinge may include a first hinge part associated with lower end of the elongate member, a second hinge part associated with the base frame and a pivot pin pinning the hinge parts together.

The first hinge part may include a pair of opposed hinge flanges extending outwardly from a sidewall of the elongate member facing the forward end at or near the lower end.

The second hinge part may include a corresponding pair of opposed hinge flanges extending outwardly from a sidewall of the yoke support cross frame member, preferably from a central portion of the yoke support cross frame member.

The various hinge parts may be configured to intercalate with one another, preferably such that the first hinge parts are received between the second hinge parts.

The respective hinge flanges may all define a central aperture for receiving the pivot pin therethrough. In such embodiments, the pivot pin may include a M8 60 mm bolt, for example.

In some embodiments, the at least one hinge may include, or be associated with a, a pivot stop for limiting pivoting movement of the yoke support member relative to the base. Advantageously, this may prevent the yoke support frame potentially crashing against other simulator equipment when pivoting to the collapsed position.

The pivot stop may be of any suitable size, shape and form.

For example, in some such embodiments the pivot stop may be in the form of a bump stop protruding upwardly from the base frame and configured to engage with the elongate member and thereby limit pivoting movement.

In other embodiments, the pivot stop may include a second pin extending between the opposed hinge flanges of the second hinge part located just forward of the pivot pin and configured to engage with corresponding edge portions of the hinge flanges of the first hinge part when the elongate member is pivoted relative to the base frame and halt the elongate member from pivoting any further. In such embodiments, the second pin may also include a M8 60 mm bolt.

As indicated, the support frame assembly further includes at least one locking arrangement for releasably securing the yoke support frame in the operable position relative to the base frame.

The at least one locking arrangement may be of any suitable size, shape and construction. The at least one locking arrangement or parts thereof may or may not be of integral formation with the elongate member and the base frame.

Generally, the at least one locking arrangement may permit the elongate member of the yoke support frame to be locked and unlocked relative to the base frame so that the elongate member can be selectively moved between the collapsed and operable positions.

The at least one locking arrangement includes a pair of locking arrangements, including a first locking arrangement operatively associated with the lower end of the elongate member and a second locking arrangement connectable to the first locking arrangement and operatively associated with the base frame, preferably the yoke support cross frame member.

For example, in some embodiments, the locking arrangement may be in the form of a latch having a latch arm associated with one of the elongate member and the yoke support cross frame member and a receiver associated with the other of the elongate member and the yoke support cross frame member and configured to engage with the latch arm and lock the elongate member relative to the yoke support cross frame member.

In other embodiments, the at least one locking arrangement may be configured to automatically lock the elongate member relative to the base frame when pivoted to the operable position. In such embodiments, the at least one locking arrangement may be in the form of slam latch including a spring loaded latch arm operatively associated with one of the elongate member and the yoke support cross frame member and a receiver or catch operatively associated with the other of the elongate member and the yoke support cross frame member and positioned to be automatically engaged by spring loaded latch arm when the elongate member is pivoted to the operable position. In such embodiments, the spring loaded latch arm may be manually depressed by a user to disengage the receiver or catch to pivot the elongate member to the collapsed position.

In other preferred embodiments, the at least one locking arrangement may be in the form of a toggle latch including a pivoting lever and drawbar associated with one of the elongate member and the yoke support cross frame member and configured to reach onto a catch associated with the other of the elongate member and the yoke support cross frame member to lock the lock the elongate member relative to the yoke support cross frame member.

Preferably, the pivoting lever and drawbar may be mounted on a rearward facing sidewall of the lower end of the elongate member and the catch may be mounted on a rearward facing sidewall of the yoke support cross fame member. In use, pivoting the lever away from the elongate member enables the drawbar to hook over, or engage with, the catch when the elongate member is in the operable position, and pivoting the lever towards the elongate member pulls the drawbar against the catch thus drawing it in and locking the elongate member relative to the yoke support cross frame member.

In preferred embodiments, the support frame assembly further includes a centre stick support frame extending upwardly from the base frame for having a centre stick mounted thereon. The centre stick support frame may be configured and positioned relative to the base frame to position a centre stick mounted thereon immediately in front of a flight simulator occupant, preferably such that the centre stick is positioned between the occupant's legs.

The centre stick support frame may be of any suitable size, shape and construction. The centre stick support frame may be of unitary construction or may be formed from two or more frame pieces, preferably the latter.

Generally, the centre stick frame, like the yoke support frame, may include an elongate member having an upper end for supporting the centre stick thereon and an opposed lower end configured to be fixedly coupled to the base frame, preferably to a central portion of the centre stick cross frame member.

The elongate member may be of tubular or solid construction, preferably the former. The elongate member may have a substantially circular, oval or rectangular cross-section, preferably rectangular.

The elongate member may be defined by at least one sidewall, preferably four sidewalls extending longitudinally between the opposed ends.

The elongate member may be of a fixed height as defined between the opposed ends or may be adjustable, preferably the latter.

In some embodiments, the height of the elongate member and thus the centre stick support frame may be adjustable by a telescopic arrangement. For example, the elongate member may include two or more telescoping member portions slidable relative to each other between a retracted position and an extended position to thereby adjust a height of the elongate member.

In preferred such embodiments, the elongate member may include a lower member portion and an upper member portion slidable relative to the lower member portion between a retracted position and an extended position to thereby adjust a height of the elongate member.

In such embodiments, the elongate member may further include a retaining mechanism for retaining the member portions at a set height. Any suitable type of retaining mechanism may be used as previously described.

In preferred embodiments, the lower member portion may include one or more elongate apertures extending at least partially along a height of the portion and the upper member portion may include one or more threaded shanks configured to protrude outwardly from a sidewall of the upper member portion and through the elongate apertures, be slidable along the elongate apertures and have a threaded fastener fastened thereon to retain or clamp the upper member portion relative to the lower member portion at a set height.

The centre stick may be directly or indirectly mounted to the elongate member, preferably the latter.

Preferably, the centre stick support frame may further include a centre stick support bracket mounted atop the elongate member for supporting the centre stick thereon.

The centre stick support bracket may be of any suitable size, shape and construction for having the centre stick mounted thereon.

Typically, the bracket may have an elongate planar shape. The bracket may include a pair of opposed surfaces, including an upper surface and an opposed lower surface. The opposed surfaces may extend substantially parallel to one another and be interconnected by opposing edges.

The bracket may be mounted atop the elongate member by one or more mechanical fasteners.

Similarly, the bracket may include one or more apertures defined thereon for receiving one or more mechanical fasteners therethrough for fastening the centre stick to the bracket.

In some embodiments, the assembly may further include one or more side support frames for supporting various simulator components, such as, e.g., a side stick, a joy stock, or a throttle, on either side of the assembly, preferably beside the seat.

The side support frames may be of any suitable size, shape and construction.

Generally, each side support frame may include a frame member having an upper end for supporting the component thereon and an opposed lower end configured to be fixedly coupled to the base frame, preferably to a second portion of a side frame member defining the raised seat mount.

In some embodiments, the frame member may extend linearly between opposed ends.

In other embodiments, the frame member may extend arcuately between the opposed ends.

Typically, each frame member may be defined by a single sidewall extending longitudinally between the opposed ends. The sidewall may have an upper edge, an opposed lower edge and opposed side edges.

In some embodiments, the frame member may include folded flange portions extending along each side edge, preferably orthogonally folded.

The frame member may include one or more apertures at the lower edge for receiving mechanical fasteners therethrough for mounting the frame member to the base frame. Preferably, the one or more apertures may be elongate apertures as previously described so as to enable the frame members to be slidably mounted relative to the base frame and thus a height of the side support frame relative to the base frame to be adjustable.

Each side support frame may further include a side support bracket mounted atop the frame member for supporting various simulator components thereon.

Each side support bracket may be of any suitable size, shape and construction for having components mounted thereon.

Typically, the bracket may have an elongate planar shape. The bracket may include a pair of opposed surfaces, including an upper surface and an opposed lower surface. The opposed surfaces may extend substantially parallel to one another and be interconnected by opposing edges.

The bracket may be mounted atop the frame member by one or more mechanical fasteners.

Similarly, each bracket may include one or more apertures defined thereon for receiving one or more mechanical fasteners therethrough for fastening components to the bracket, such as, e.g., a side stick.

According to a third aspect of the present invention, there is provided a method of pivoting a yoke support frame relative to a base frame of a flight simulator cockpit to facilitate entrance and exit from the cockpit, said method including:
providing a flight simulator cockpit having a support frame assembly according to the first aspect;
releasing the at least one locking arrangement so as to release the elongate member of the yoke support frame relative to the base frame; and
pivoting the yoke support frame away from the seat into the folded position so as to provide unimpeded access to and from the seat when entering or exiting the flight simulator cockpit.

The method may include one or more features or characteristics of the support frame assembly and yoke support frame assembly as hereinbefore described.

Any of the features described herein can be combined in any combination with any one or more of the other features described herein within the scope of the invention.

The reference to any prior art in this specification is not and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 is an upper perspective view of a support frame assembly for a flight simulator cockpit according to an embodiment of the present invention;

FIGS. 2A and 2B show side views of the support frame assembly as shown in FIG. 1 with a yoke support frame shown in operable and collapsed positions, respectively; and

FIGS. 3A to 3C respectively show enlarged views of the yoke support frame of the support frame assembly as shown in FIGS. 1, 2A and 2B transitioning from the operable position to the collapsed position.

### DETAILED DESCRIPTION

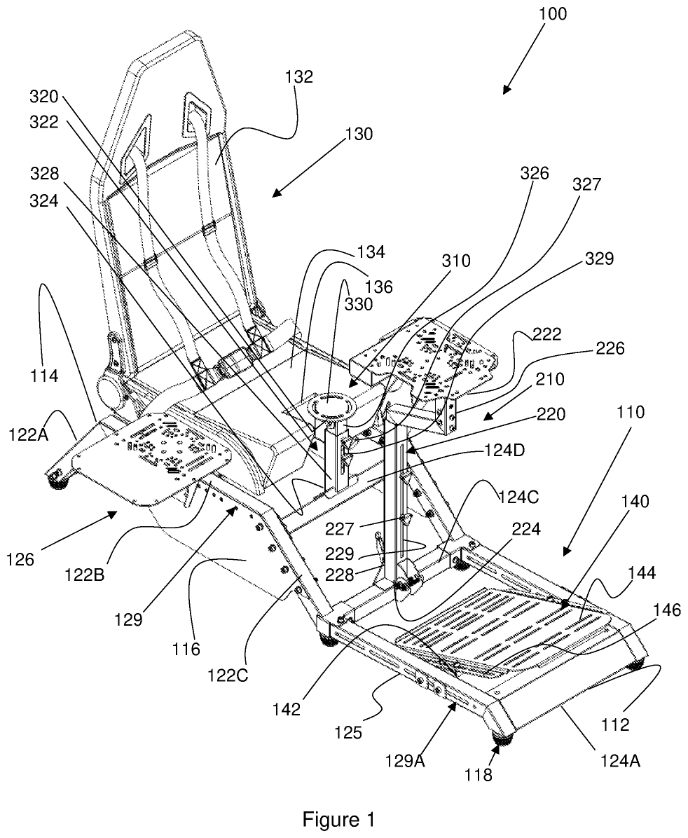

FIGS. 1, 2A, 2B and 3A to 3C show an embodiment of a support frame assembly (100) and parts thereof for a flight simulator cockpit.

Referring to FIG. 1, the support frame assembly (100) includes: a base frame (110) defining a forward end (112), an opposed rear end (114) and opposed sides (116) extending therebetween; a seat (130) mounted to the base frame (110) at or near the rear end (114), a pedal set support frame (140) mounted to the base frame at or near the forward end (112) for supporting a pedal set thereon; and a yoke support frame (210) extending upwardly from the base frame (110) at a location positioned in front of the seat (130) for supporting a yoke centrally in front of a seat occupant.

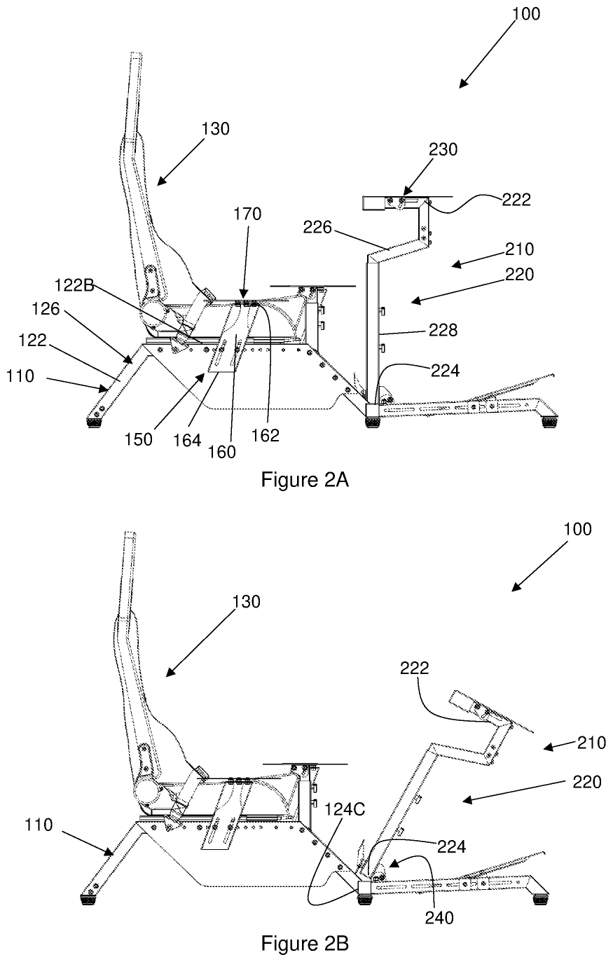

The yoke support frame (210) includes an elongate member (220) having an upper end (222) for supporting a yoke thereon and an opposed lower end (224) pivotally mounted to the base frame (110) so that the yoke support frame (210) is pivotable between a folded position in which the yoke support frame pivots away from the seat (130) to provide unimpeded access to and from the seat (130) when entering or exiting the flight simulator, as shown in FIG. 2B, and an operable position, as shown, in which the yoke support frame (210) stands proud relative to the base frame (110).

The assembly (100) further includes a locking arrangement for releasably securing the yoke support frame (210) in the operable position relative to the base frame (110).

Moreover, the support frame assembly (110) includes a centre stick support frame (310) extending upwardly from the base frame (110) for having a centre stick mounted thereon. The centre stick support frame (310) is configured and positioned relative to the base frame (110) to position a centre stick mounted thereon immediately in front of a flight simulator occupant such that the centre stick is positioned between the occupant's legs.

The base frame (110) has a rectangular shape is formed from metal.

The base frame (110) is formed from a pair of longitudinally extending side frame members (122) joined together by a plurality of cross frame members (124), including a forward cross frame member (124A), a rear cross frame member (124B; not visible), a yoke support cross frame member (124C) and a centre stick support cross frame member (124D).

The forward and rear cross frame members (124A, 124B) respectively define the forward and rear ends (112, 114) of the base frame (110).

The frame members (122, 124) are of a tubular construction having a rectangular cross-section.

Each frame member (122, 124) includes a pair of opposed ends and an elongate body defined by four sidewalls (125) extending therebetween.

The various frame members (122, 124) are joined together using one or more mechanical fasteners.

As shown, the side frame members (122) include one or more bends near the rear end (114) to define a raised seat mount (126) atop of which the seat (130) is mounted.

The seat mount (126) is configured to position the seat (130) at an optimal height above a support surface so that an occupant can readily view one or more display screens positioned in front of the flight simulator.

The side frame members (122) forming the raised seat mount (126) include three portions when viewed from a side: a first portion (122A), a second portion (122B) and a third portion (122C) that together form the raised seat mount (126). The first and third portions (122A, 122C) are acutely angled relative to a support surface and the second portion (122B) bridges the first and third portions (122A, 122C) and extends substantially parallel to the support surface.

The base frame (110) further includes feet (118) for supporting the base frame (110) and a remainder of the support frame assembly (100) atop a support surface.

The feet (118) are formed from plastic material and are height adjustable by rotating each foot (118) relative to the base frame (110).

As also shown, the various frame members (122, 124) forming the base frame (110) include apertures (129) defined in walls (125) thereon for mounting various components.

For example, the apertures (129) defined in sidewalls (125) of the second portion (122B) of the side frame members (122) are for the mounting various side components to the base frame (110).

Likewise, the apertures (129A) defined in the sidewalls (125) of the side frame members (122) at the forward end (112) are for the mounting the pedal set support frame (140) thereto. Further, these apertures (129A) are elongate apertures for the mounting of various components thereto with one or more mechanical fasteners so that they are be slidably adjustable therealong.

As indicated, the seat (130) is mounted to the raised seat mount (126) of the base frame (110) near the rear end (114).

The seat (130) is a seat configured to be suitable for a flight simulator.

The seat (130) includes an adjustable backrest (132) configured to pivot relative to the seat base (134).

As shown, the forward edge of the seat base (134) includes a cut out portion (136) configured to accommodate the centre stick support frame (310) extending upwardly at least partially therethrough.

The seat (130) is indirectly mounted to the raised seat mount (126) via one or more seat brackets and a seat slider mechanism configured to enable the seat (130) to be slidably adjustable relative to the base frame (110).

As indicated, the support frame assembly (100) further includes a pedal set support frame (140) for supporting a pedal set thereon.

The pedal set support frame (140) include a cross frame member (142) configured to extend longitudinally between the opposed side frame members (122) of the base frame (110) and a pedal set support bracket (144) mounted atop the cross frame member (142) for supporting the pedal set thereon.

The cross frame member (142) includes a pair of opposed ends and an elongate body extending therebetween.

Each end is configured to be slidably mountable to an inner sidewall (125) of an adjacent side frame member (122) via one or more mechanical fasteners received through the elongate apertures (129A) defined in the sidewalls (125) as previously described.

The upper surface of the cross frame member (142) is partially angled towards the seat (130) such that the pedal set support bracket (144) when mounted thereon is also partially angled towards the seat (130).

The pedal set support bracket (144) has an elongate planar shape. The bracket (144) includes elongate apertures (146) extending along the opposed sides for fastening the bracket (144) atop the cross frame member (142) and to enable the bracket (144) to be slidably adjusted relative to the cross frame member (142).

Referring to FIGS. 2A and 2B, the yoke support frame (210) extends upwardly from the base frame (110) for supporting a yoke relative to the base frame (110) in a position centrally positioned in front of a seat occupant.

As shown, the yoke support frame (210) is pivotable relative to the base frame (110) between an operable position in which the yoke support frame (210) stands proud relative to the base frame (110), as shown in FIG. 2A, and a folded position in which the yoke support frame (210) pivots away from the seat (130) to provide unimpeded access to and from the seat (130) when entering or exiting the flight simulator, as shown in FIG. 2B.

Referring to FIG. 2A, the elongate member (220) of the yoke support frame (210) is formed from an upper member portion (226) and a lower member portion (228) arranged in a telescopic arrangement. The upper member portion (226) is slidable relative to the lower member portion (228) between a retracted position and an extended position to thereby adjust a height of the elongate member (220).

Referring briefly to FIG. 1, the lower member portion (228) further includes an elongate aperture (229) extending along a height of the portion (228) and the upper member portion (226) includes one or more threaded shanks (227) configured: to protrude outwardly from the upper member portion (226) and through the elongate apertures (229), be slidable along the elongate apertures (229) and have a threaded fasteners fastened thereon to retain or clamp the upper member portion (226) relative to the lower member portion (228) at a set height.

Referring back to FIG. 2A, the lower member portion (228) extends linearly between the lower end (224) and an opposed upper end in which the upper member portion (226) is slidably received.

The upper member portion (226) includes a linear lower end configured to be at least partially received in the upper end of the lower member portion (228) and an angled upper end (222) defining an angular crook facing the seat (130) and having an upper substantially planar surface for the mounting of the yoke thereon.

The yoke support frame (210) further includes a yoke support bracket (230) mounted atop the elongate member (220) for supporting the yoke thereon.

The bracket (230) has an elongate planar shape and is mounted atop the elongate member (210) by one or more mechanical fasteners received through apertures defined near the upper end (222).

Referring to FIG. 2B, the elongate member (220) is pivotally mounted to the base frame (110) to allow the elongate member (220) to pivot about the lower end (224) and the upper end (222) to be pivotable between the operable and folded positions.

Specifically, the elongate member (220) is hingedly connected at its lower end (224) to the yoke support cross frame member (124C) by at least one hinge (240).

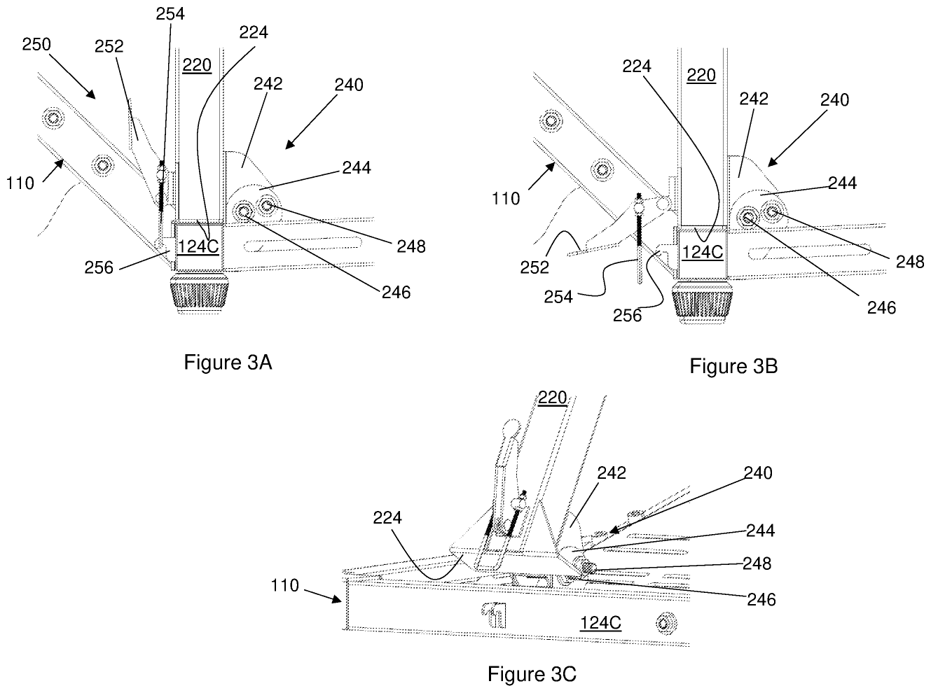

Referring to FIGS. 3A to 3C and best shown in FIG. 3C, the at least one hinge (240) includes a first hinge part (242) including a pair of opposed hinge flanges extending outwardly from a sidewall of the elongate member (220) towards the forward end (112; not shown) at the lower end (224) and a second hinge part (244) including a pair of opposed hinge flanges extending outwardly from a central portion of a sidewall of the yoke support cross frame member (124C) towards the forward end (112; not shown), and a pivot pin (246) pinning the hinge parts (242, 244) together.

The various hinge parts (242, 244) intercalate with one another such that the first hinge parts (242) are received between the second hinge parts (244).

The respective hinge flanges all define a central aperture for receiving the pivot pin (246) therethrough.

The hinge (240) further includes a pivot stop for limiting pivoting movement of the yoke support member (210) relative to the base (110). The pivot stop includes a second pin (248) extending between the opposed hinge flanges of the second hinge part (244) located just forward of the pivot pin (246) and configured to engage with corresponding edge portions of the hinge flanges of the first hinge part (242) when the elongate member (220) is pivoted relative to the base frame (110) and halt the elongate member (220) from pivoting any further.

Referring to FIG. 3A, and as previously indicated, the support frame assembly (100) further includes a locking arrangement for releasably securing the yoke support frame (210) in the operable position relative to the base frame (110).

The locking arrangement is in the form of a toggle latch (250) including a pivoting lever (252) and drawbar (254) mounted to the lower end (224) of the elongate member (220) and rearward facing and a catch (256) centrally mounted on a rearward facing sidewall of the yoke support cross frame member (124C). As shown, the drawbar (254) is configured to hook over the catch (256) to lock the elongate member (220) relative to the yoke support cross frame member (124C).

Referring to FIG. 3B, in use, pivoting the lever (252) away from the elongate member (220) enables the drawbar (254) to hook over the catch (256) when the elongate member (220) is in the operable position, and pivoting the lever towards the elongate member (220) pulls the drawbar (254) against the catch (256) thus drawing it in and locking the elongate member (220) relative to the yoke support cross frame member (124C) as shown in FIG. 3A.

Referring back to FIG. 1, and as indicated, the centre stick support frame (310) extending upwardly from the base frame (110) for having a centre stick mounted thereon.

Like the yoke support frame (210), the centre stick support frame (310) includes an elongate member (320) having an upper end (322) for supporting the centre stick thereon and an opposed lower end (324) configured to be fixedly coupled to a central portion of the centre stick cross frame member (124D).

The elongate member (320) of the centre stick support frame (310) is formed from an upper member portion (326) and a lower member portion (328) arranged in a telescopic arrangement. The upper member portion (326) is slidable relative to the lower member portion (328) between a retracted position and an extended position to thereby adjust a height of the elongate member (320).

Further, and like the elongate member (220) of the yoke support frame (210), the lower member portion (328) further includes an elongate aperture (329) extending along a height of the portion (328) and the upper member portion (326) includes one or more threaded shanks (327) configured: to protrude outwardly from the upper member portion (326) and through the elongate apertures (329), be slidable along the elongate apertures (329) and have threaded fasteners fastened thereon to retain or clamp the upper member portion (326) relative to the lower member portion (328) at a set height.

The centre stick support frame (310) further includes a centre stick support bracket (330) mounted atop the elongate member (320) for supporting a centre stick thereon.

The bracket (330) has a planar shape and is mounted atop the elongate member (220) by one or more mechanical fasteners.

Referring to FIG. 2A, and as shown, the assembly (100) further includes side support frames (150) for supporting various simulator components, such as, e.g., a side stick, a thruster, a keyboard, or a mouse, on either side of the assembly (100) beside the seat (130).

Each side support frame (150) includes a frame member (160) having an upper end (162) for supporting a component thereon and an opposed lower end (164) fixedly coupled to the second portion (122B) of a side frame member (122) defining the raised seat mount (126).

Each frame member (160) extends arcuately between the opposed ends.

Each side support frame (150) further includes a side support bracket (170) mounted atop the frame member (160) for supporting the various simulator components thereon.

The brackets (170) have an elongate planar shape and are mounted atop the respective frame members (160) by one or more mechanical fasteners.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A support frame assembly for an interchangeable flight simulator cockpit, said support frame assembly comprising:
a base frame defining a forward end and an opposed rear end;
a seat mountable to the base frame at or near the rear end;
a pedal set support frame mountable to the base frame at or near the forward end for supporting a pedal set thereon;
a yoke support frame extending upwardly from the base frame at a location positioned in front of the seat for supporting a yoke centrally in front of a seat occupant, said yoke support frame comprising an elongate member having an upper end for supporting the yoke thereon and an opposed lower end pivotally mountable to the base frame so that the yoke support frame is pivotable between a folded position in which the yoke support frame pivots towards the base frame and an operable position in which the yoke support frame stands proud relative to the base frame;
at least one locking arrangement for releasably securing the yoke support frame in the operable position relative to the base frame; and
a centre stick support frame for supporting a centre stick thereon and wherein a forward edge of the seat comprises a cut out portion for at least partially accommodating the centre stick support frame extending upwardly from the base frame and at least partially therethrough,
wherein the flight simulator cockpit is interchangeable between at least two configurations, comprising a domestic or commercial aircraft configuration in which the cockpit is configured to simulate a domestic or commercial aircraft cockpit characterised by a yoke for controlling at least altitude and a military aircraft configuration in which the cockpit is configured to simulate a military aircraft cockpit characterised by a centre stick.

2. (canceled)

3. (canceled)

4. The assembly of claim 1, wherein the pedal set support frame is slidably mountable to the base frame.

5. The assembly of claim 1, wherein the yoke support frame is of adjustable height.

6. The assembly of claim 5, wherein the elongate member of the yoke support frame comprises a lower member portion and an upper member portion slidable relative to the lower member portion between a retracted position and an extended position to thereby adjust a height of the elongate member and thus the yoke support frame.

7. The assembly of claim 6, wherein the elongate member further comprises a retaining mechanism for retaining the upper member portion relative to the lower member portion.

8. The assembly of claim 7, wherein the retaining mechanism comprises:
one or more elongate apertures extending at least partially along a height of the lower portion;
one or more threaded shanks protruding outwardly from a sidewall of the upper member portion through the elongate apertures, said one or more threaded shanks configured to be slidable along the elongate apertures;
one or more threaded fasteners configured to fasten on the one or more threaded shanks to retain or clamp the upper member portion relative to the lower member portion at a desired height.

9. The assembly of claim 8, wherein an upper end of the upper member portion comprises one or more angled bends defining an angular crook facing the seat and defining a substantially planar surface for mounting of the yoke thereon.

10. The assembly of claim 1, wherein the elongate member of the yoke support frame further comprises a yoke support bracket mounted atop the elongate member for supporting the yoke thereon.

11. The assembly of claim 1, wherein the elongate member of the yoke support frame is hingedly connectable to the base frame by at least one hinge so as to be pivotable between the folded and operable positions.

12. The assembly of claim 11, wherein the at least one hinge comprises a first hinge part associated with the lower end of the elongate member, a second hinge part associated with the base frame and a pivot pinning the first hinge part and the second hinge part together.

13. The assembly of claim 12, wherein the base frame further comprises a pivot stop for supporting the yoke support frame when in the folded position and preventing the yoke support frame from over pivoting.

14. The assembly of claim 13, wherein the pivot stop comprises a pin located in the second hinge part forward of the pivot pin and configured to engage with the first hinge part when the elongate member is pivoted relative to the base frame to limit its movement relative thereto.

15. The assembly of claim 1, wherein the at least one locking arrangement comprises a pair of locking arrangements comprising a first locking arrangement operatively associated with the lower end of the elongate member and a second locking arrangement connectable to the first locking arrangement and operatively associated with the base frame.

16. The assembly of claim 1, wherein the at least one locking arrangement comprises a latch having a latch arm associated with one of the elongate member and the base frame and a receiver associated with the other of the latch arm and the base frame and configured to engage with the latch arm and lock the elongate member relative to the base frame.

17. The assembly of claim 1, wherein the at least one locking arrangement comprises a toggle latch comprising a pivoting lever and drawbar associated with one of the elongate member and the base frame and configured to reach onto a catch associated with the other of the elongate member and the base frame to lock the elongate member relative to the base frame.

18. The assembly of claim 17, wherein the pivoting lever and drawbar are mounted on a rearward facing side wall of a lower end of the elongate member and the catch is mounted on a rearward facing sidewall of a yoke support cross frame member of the base frame and wherein, in use, pivoting the lever away from the elongate member enables the drawbar to hook over, or engage with, the catch when the elongate member is in the operable position and pivoting the lever towards the elongate member pulls the drawbar against the catch thus drawing it in and locking the elongate member relative to the yoke support frame member.

19. The assembly of claim 1, wherein the at least one locking arrangement is configured to automatically lock the elongate member relative to the base frame when pivoted to the operable position.

20. The assembly of claim 19, wherein the at least one locking arrangement is a slam latch comprising a spring-loaded latch arm operatively associated with one of the elongate member and the base frame and a receiver or catch operatively associated with the other of the elongate member and the base frame and positioned to be automatically engaged by spring loaded latch arm when the elongate member is pivoted to the operable position.

21. A method of pivoting a yoke support frame relative to a base frame of a flight simulator cockpit to facilitate entrance and exit from the cockpit, said method comprising:
providing a flight simulator cockpit having a support frame assembly according to claim 1;
releasing the at least one locking arrangement so as to release the elongate member of the yoke support frame relative to the base frame; and
pivoting the yoke support frame away from the seat into the folded position so as to provide unimpeded access to and from the seat when entering or exiting the flight simulator cockpit.
